(19) United States
(12) Patent Application Publication
(10) Pub. No.: US 2024/0220897 A1
(43) Pub. Date: Jul. 4, 2024

(54) DATA PACKAGES FOR FAST DATA PROCESSING IN LIFE CYCLE ASSESSMENT

(71) Applicant: GreenDelta GmbH, Berlin (DE)

(72) Inventor: Michael SROCKA, Berlin (DE)

(21) Appl. No.: 17/923,876

(22) PCT Filed: Jun. 27, 2022
(86) PCT No.: PCT/EP2022/067630

§ 371 Date: Nov. 7, 2022

Related U.S. Application Data
(60) Provisional application No. 63/215,409, filed on Jun. 25, 2021.

(51) Int. Cl. G06Q 10/0633

(52) U.S. Cl. CPC G06Q 10/0633

(57) ABSTRACT

A system (100) for implementing and/or providing a life cycle assessment, the system (100) comprising a foreground system (102) communicating with a background system (104), the background system (104) comprising background databases (106) including background process datasets, the foreground system (102) comprising a foreground database (108) including foreground process datasets, a computing device (110) for creating a life cycle assessment model and for performing a life cycle assessment (LCA), the foreground system (102) being configured to store at least one data package (114) including the background process datasets stored in a package format, the computing device (110) being configured to receive the background process datasets from the at least one data package (114).

The present invention relates to systems and methods for fast data processing in Life Cycle Assessment, and more particularly to the systems and methods configured to utilize (pre-calculated) data packages for implementing and calculating Life Cycle Assessment models in an improved, time- and memory-efficient (less time and memory consuming) manner.

Life Cycle Assessment (LCA) is a method assessing environmental, social and economic impacts of a product or service along its life cycle. The method is standardized in ISO 14040. Most commonly, an LCA assesses the environmental impacts throughout the entire life cycle, e.g. from raw material extraction, through manufacturing, use, maintenance and/or recycling, to the end-of-life of a product or a service.

An LCA model is typically comprising a foreground system including specifically collected data, and a background system of data taken from generic databases. The background databases comprise a large amount of generic process datasets stored therein, e.g. for electricity production, materials, or transports, that are often used as a foundation of an LCA model.

The processes in a background database are typically highly connected, and thus, a specific LCA model often includes almost all background processes. As a consequence, the calculation of such a model, which is done using computer software, needs to calculate typically large amounts of data, which is resource (in terms of computer memory) and time consuming.

The foreground system comprises processes that are specific to a given question of the LCA (the so-called foreground processes). Such foreground systems are typically small compared to the background systems that normally comprise thousands of interconnected background processes.

While the foreground systems being specific to a case, typically created by users (i.e. the decision-makers of a given LCA study), the background systems usually include purely static process information that is provided by a database provider. The background system is connected to the foreground system by input of generic products or generic waste treatment of waste flows of the foreground system: e.g. a system needs a certain amount of medium voltage grid electricity, transportation by truck, and so forth.

In addition, in cases of specific applications, such as environmental product declarations, it is even essential to employ specified background databases without modification.

According to one known approach, in a calculation step of an LCA, e.g. for calculating a life cycle inventory, a LCA model is typically transformed into a system of linear equations which have to be solved. To this end, the processes and their input and output flows of an LCA model are represented in matrices. These matrices may comprise thousands of rows and columns depending on the number of foreground processes incorporated in the LCA model. Thus, calculating an LCA including a large number of background process datasets can be a computationally intensive task regarding computation time and memory requirements.

In addition, the size of the background databases is steadily increasing. The size of the background databases directly affects the computational requirements and the handling/implementing of the LCA models that are linked to such large background databases.

Another problem of LCA models with large background databases is the handling of them in graphical editors through graphical interfaces. That is, the processes of different stages of the life cycle are connected by the corresponding input and output flows graphically. However, this becomes very complex in cases of large LCA models that require handling and defining the connections between thousands of the processes. These drawbacks can be handled e.g. by collapsing the most of the processes and their connections. This is however typically undesired for the foreground processes.

In a common matrix based LCA method, first a technosphere matrix A is created, that contains the linked product or waste flows of an LCA model. The life cycle system under study is then calculated for a set of product amounts, namely a final demand f (the net system output). To this end, the first task in the matrix based LCA method is to calculate the scaling vector s for which the system provides, or supplies, the set of product amounts. This is performed by solving the following equations (see Heijungs and Suh 2002, “The Computational Structure of Life Cycle Assessment”, 2002, Volume 11, ISBN: 978-90-481-6041-9):

$$As = f$$

The scaling vector is then used to calculate an inventory result g from a corresponding intervention matrix B that contains amounts of elementary flows, like consumed resources, emissions, or final waste flows of the system:

$$Bs = g$$

The inventory result can be used to calculate a Life Cycle Impact Assessment (LCIA) result h by multiplying the same with characterization factors corresponding to different LCIA categories that are stored in a matrix C:

$$Cg = h$$

When using large background databases, the matrices A, B, and C can be very large. Further, depending on the type of background database, these matrices can be sparse in cases of unit process databases or dense in cases of input-output models.

In an LCA software tool, the aforesaid matrices are typically created dynamically when the user starts a calculation step. Depending on the sparsity, the system then typically tries to switch to a specific solver to improve the calculation time and the memory requirements. However, even with the optimized solvers the creation of the matrices in a dynamic manner and the calculation thereof are nevertheless computationally an intensive task. This in turn, massively will slow down the workflow, in particular when building the LCA models using large background databases.

One way to solve these problems is to use pre-calculated system processes as background data in an LCA model. This makes the calculation much faster and the handling of the model in a graphical editor much easier. However, detailed results regarding contributions of the background processes (in upstream trees, Sankey diagrams etc.) are not possible this way. Also, it can massively reduce the performance of the database system when a large background system is stored in the same way as the foreground system.

The handling of large background databases behind (underlying) an LCA model may therefore result in reaching the limits of what is possible during a calculation in terms of memory requirements and computing time, as well as during modelling using the graphical editors.

The object of the present invention is achieved by the system according to independent claim 1 and the method according to independent method claim 14. Further advantageous embodiments can be realized by the systems and methods according to the dependent claims.

In particular, a system for implementing and/or providing a life cycle assessment is provided. The system comprises a foreground system in communication with a background system. The background system comprises background databases including background process datasets. The foreground system comprises a foreground database including foreground process datasets. A computing device is configured for creating a life cycle assessment model and for performing a life cycle assessment of the combined system.

In addition, the foreground system is configured to store at least one data package that includes the background process datasets stored in a package format. Further, the computing devices are configured to receive the background process datasets from the at least one data package.

In particular, the system is configured to provide an LCA model and the LCA model is made from the foreground and background system. The whole model is accessible through a software tool.

In other words: The system is capable to compute life cycle systems, which then allows to be provided with a life cycle assessment

In particular, the at least one data package may comprise large background databases stored therein in a specific package format. The data packages are therefore supported by the LCA software tool for efficient handling of large background databases.

Particularly, the at least one data package may comprise precalculated, or pre-processed, matrices of the background databases (i.e. associated with the background process datasets). The pre-calculated matrices, or matrix files, of the background databases facilitates fast implementation of the LCA, in that the time required for loading and linking the background process datasets into an LCA model is massively reduced, i.e. the background process datasets can be easily incorporated in the calculation by the LCA tool.

In addition, the provision of the data package also reduces the calculation time of the LCA model. This is, in particular due to the application of block-matrix algorithms, and due to the effective loading and scaling of the matrix files that are stored in the background database.

Consequently, the use of the at least one data package considerably reduces the time required for implementing an LCA model as it provides for a combined LCA effectively incorporating the background process datasets into the software tools of the foreground system.

In particular, by storing the background process datasets of the large background databases in a specific data package format (including the pre-calculated matrices) and by linking the pre-calculated matrices to the foreground system (incorporating the matrices into the LCA model), the large amount of the background process datasets can be handled and analyzed in an efficient and improved manner. This in turn improves internal functioning of the software tools (or the computing devices), thereby leading to a massive decrease of the computation time and memory requirements when implementing and calculating such a combined LCA model. In addition, the combined LCA model is also configured to provide for detailed results and analysis features.

The use of the at least one data package further provides for a clean separation between the foreground system and the background system of an LCA model. In this way, it is possible to advantageously isolate the foreground system, i.e. to exclude details and elements of the background system therefrom, thereby reducing the complexity of the modeling when using the graphical editors.

In addition, the at least one data package may further comprise meta-data files that comprise information about the library (name, version, description) and possible dependencies to other libraries.

In particular, the at least one data package further comprises meta-data of all elements that are stored in the background databases, and index files for linking the meta-data to the specific rows and columns of the pre-calculated matrices of the data packages.

In particular, the at least one data package may comprise all meta-data of the elements stored in the library (process and flow attributes, sources, units etc.).

Further, the at least one data package may comprise the pre-calculated matrices stored in a specific format, such as a fast binary format. In this way, the complete matrix or parts thereof can be mapped into a memory of the system for conducting the calculation step in a very fast way.

Furthermore, the system is configured to employ various storage formats for the pre-calculated matrices, e.g. a sparse or dense matrix storage format, depending on the type of the background databases, which include, for example, either sparse unit-process databases or dense input-out models. In this way, the pre-calculated matrices are configured to support the corresponding type of the background database more efficiently regarding memory usage and data processing time.

In particular, the meta-data in the at least one data package is configured to fully describe the characteristic features thereof as well as the characteristic features of the LCA model (e.g. processes, flows, LCA methods, etc).

In particular, the results obtained from a system including a combined LCA model advantageously includes the same characteristics as the results obtained from a single uniform unit-process system. That is, every result-contribution can be tracked down to the respective process in the supply chain. In this way, the visualization of the results of the combined LCA model, e.g. by way of contribution charts, upstream tress and/or Sankey diagrams, can be constructed in a similar way as to an LCA model without the pre-calculated data packages.

Accordingly, systems and methods of embodiments include a functionality in which the background process datasets can be pre-calculated and provided in data packages. In particular, data is or can be stored in data packages and these packages have a specific format.

The systems including the pre-calculated data packages for LCA software are therefore configured to enable a user to store and retrieve information from down the supply chain within the background databases. In particular, the at least one pre-calculated data package comprises the complete background process datasets and thus, it enables the user to retrieve supply chain information stored in the background database to be used by the LCA model for performing LCA. The data packages are or can be static and read-only.

In particular, a plurality of pre-calculated data packages can be linked to a single foreground database of the foreground system. Also, a data package can be configured to be linked to other data packages recursively.

Accordingly, starting from the foreground system, an acyclic graph of data dependencies is formed. Main difference is that the foreground systems and processes can be edited, or adapted, using the LCA software tool, whilst the data packages contain read-only data. However, the elements of the data package can be used like any other data element in the LCA software tool so that it is easy for the user to combine foreground systems with the background data within the data packages via a graphical user interface.

In particular, by way of the system and method according the present invention, the step of calculating LCA models with the linked at least one data packages can be performed much faster and in a more memory efficient manner. Further, such combined LCA models are configured to provide for all (possible) result details of an LCA.

The background data is advantageously stored in the static matrix files, which store matrices in a fast binary format. This further enhances the efficiency of the system and the method for performing an LCA, as the matrix files can efficiently be included (e.g. via memory mapping) in the LCA (calculation) model.

In particular, different calculation methods can advantageously be applied to the obtained LCA results if desired or on demand. This can be implemented using the matrices and the linking the same to the LCA model through the linking mechanism of the data packages.

In addition, the system is configured to facilitate the isolation of the foreground system from the background system. This leads to a distinct separation between foreground and background systems and makes it possible to hide the details of the background system from the graphical editors, which in turn results in a more useful modeling via the graphical editors.

Further details and advantages of the present invention shall now be disclosed in the connection with the enclosed drawing.

It is shown in:

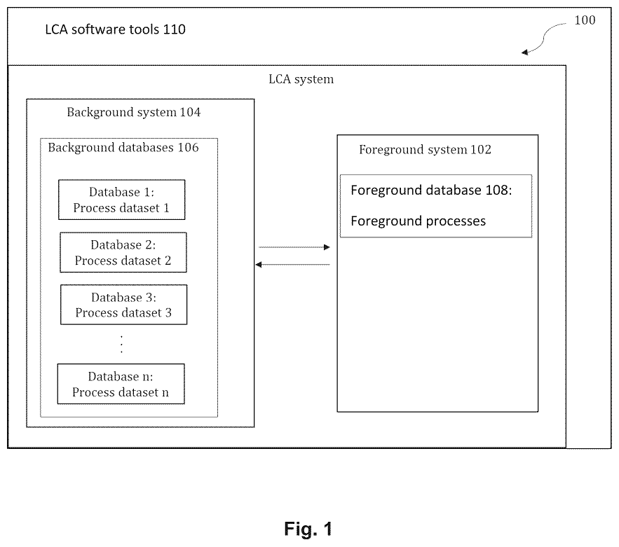

FIG. 1: a schematic illustration of a known LCA system;

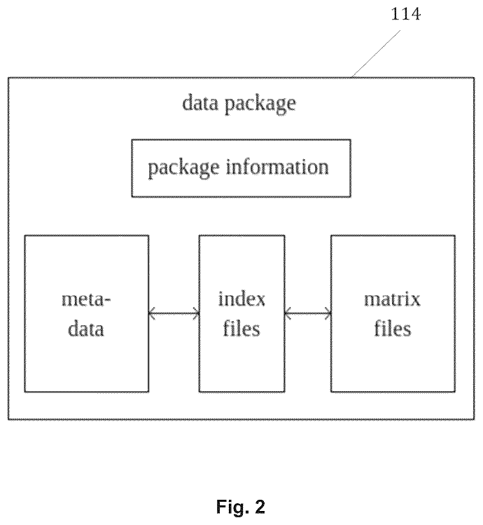

FIG. 2: a schematic illustration of a data package according to the present invention;

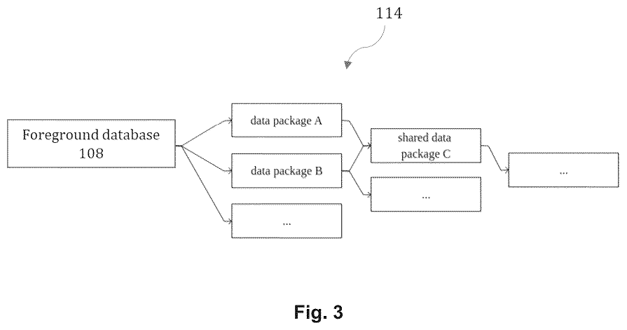

FIG. 3: a schematic illustration of dependencies between data packages according to the present invention;

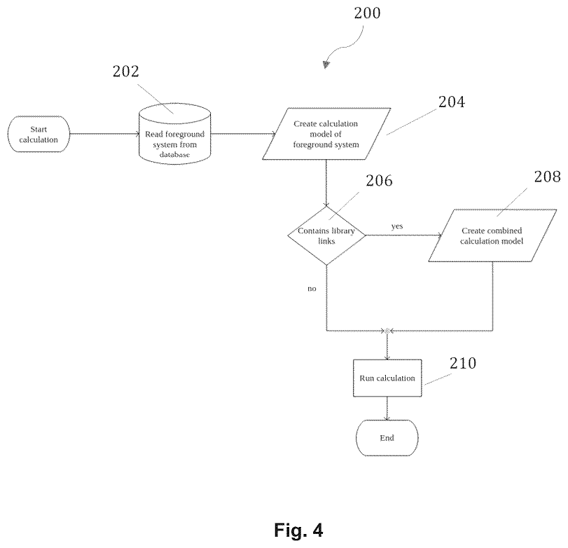

FIG. 4: a block diagram of a method for performing LCA according to the present invention;

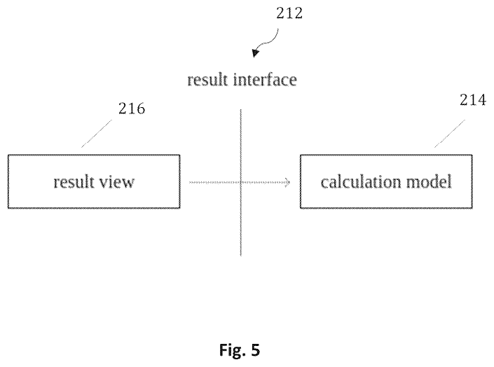

FIG. 5 a schematic illustration of a common result interface;

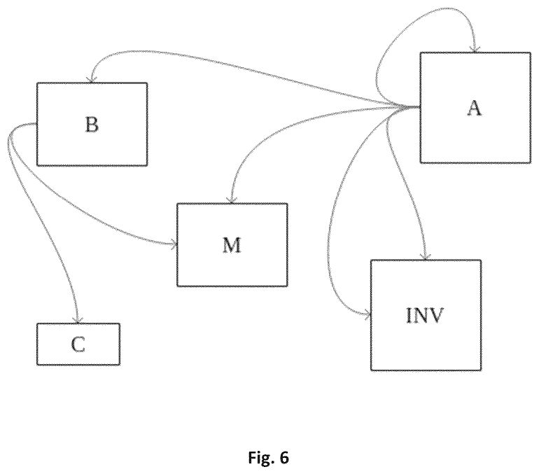

FIG. 6: a schematic illustration of index sharing between matrices of the data packages according to the present invention;

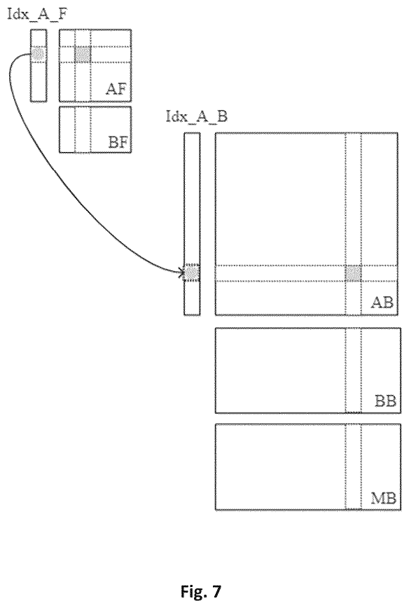

FIG. 7: a schematic illustration of a (connection) link between the foreground and background systems according to the present invention;

An exemplary illustration of a LCA system 100 is shown in FIG. 1. The LCA system 100 comprises a foreground system 102 coupled to a background system 104. The background system 104 comprises background databases 106 (e.g. background database 1 to background database n) and corresponding background process datasets stored therein (i.e. datasets 1 to datasets n).

The foreground system 102 comprises a foreground database 108 with foreground processes. The software tool 110 is configured to build an LCA model for performing LCA on the basis of the background process datasets from the background system and the foreground processes.

In particular, the LCA system 100 is configured to provide an LCA model and the LCA model is made from the foreground and background system. The whole model is accessible through a software tool.

In particular, the LCA system 100 is configured to receive, or incorporate, a data package 114 of a background database (i.e. including the data and information regarding the background process datasets in a specific package format) as shown in FIG. 2.

A data package of a background database as shown in FIG. 2 comprise of a set of files stored therein, such as the following data components (elements):
a meta-data file that comprises information about the library (name, version, description) and possible dependencies to other libraries;
a data package that comprises all meta-data of the elements stored in the library (process and flow attributes, sources, units etc.);
pre-processed matrices in a fast binary format; and
index files that map meta-data to the respective columns and rows of the matrices in the package.

Accordingly, the data package 114 may comprise large background databases stored therein in a specific package format. Particularly, the data package 114 may comprise precalculated, or pre-processed, dense or sparse matrices of the background databases in the fast binary format.

Further, the data package 114 contains the meta-data file that comprises information about the library, e.g. name, version, description, and about possible dependencies to other libraries.

In particular, the data package 114 comprises all meta-data of the elements stored in the library (process and flow attributes, sources, units etc.).

In particular, the data package 114 may further comprise other data packages as dependencies. Alternatively, a data package 114 may consist meta-data only.

In particular, the data package 114 can be stored in various formats for better exchanging of data and information in the LCA system 100 (the so-called LCA data exchange format). For example, the JSON based openLCA schema (olca-schema 2022) can be used as the format to store the meta-data. One of the advantages of this format is that it supports references between different types of LCA datasets (processes, flows, unit groups, etc.). In this way, the data packages can be configured to share common meta-data like elementary flow lists or unit systems.

FIG. 3 indicates an exemplary architecture of the data packages indicating dependencies therebetween. In particular, when a data package 114, e.g. a data package A, is added to the foreground database 108 of the foreground system 102, all the meta-data of that data package A and its dependencies, e.g. the data package B, C are added to the foreground database 108 as read-only data.

Further, the added meta-data are tagged to identify the origin thereof, i.e. to which data package are the meta-data belonging.

The elements of the data packages can be then used and linked to other elements in the foreground system 102 just as any other element in the foreground database and system 102.

In particular, in the graphical editors, the details of the background system 104 can be easily hidden which makes the LCA models that employ the data packages much clearer.

FIG. 4 illustrates an exemplary block diagram of a method 200 for performing an LCA using the LCA system 100 as described above. The method, i.e. the calculation flow, comprises the steps of:
Reading 202 the foreground database of the foreground system 102;
Building/creating 204 an LCA model for the foreground system 102;
Determining 206 whether the LCA model is connected to one or more data packages 114;
Creating 208 a combined LCA model, when the one or more data packages 114 are connected and implementing 210 the combined LCA model, i.e. running the calculation; in particular, if there are package/library links, run the calculation of a combined model, otherwise run a normal calculation;
Alternatively, if no data packages are connected, implementing 210 the LCA model.

In particular, when an LCA model is calculated, the LCA system 100 first checks if the LCA model is connected to one or more data packages 114 having the pre-calculated matrices. If this is the case, a combined calculation model is created from which results can be calculated efficiently. The system is further configured to implement the LCA models without data packages, ‘normal’ LCA models.

FIG. 5 illustrates an exemplary block diagram of a common result interface. The common result interface is implemented for different types of calculation models, e.g. the LCA models
with linked data packages 114 or without;
with dense and/or sparse matrices of the background databases 106;
for eager or lazy calculations, e.g. with full matrix inversion for upstream analysis.

When the data packages 114 are used in an LCA model, the pre-calculated matrices (matrix data) are efficiently included in the calculation model so that results can be calculated very fast with details for all background and foreground processes of the LCA system 100.

According to an exemplary embodiment, a data package 114, may comprise inventory data and/or LCIA characterization factors. In particular, the data package may further comprise the corresponding matrices A, B, and C (as described above).

The matrices are prepared and stored in an efficient binary format in the respective data package folder.

If the inventory data are available, the inverse of the technology matrix A⁻¹ (INV) as well as the intensity matrix M, which contains in each column/the inventory result related to one unit of product or waste flow j, are also stored in the data package as follows:

$$M = {BA}^{- 1}$$

The inventory matrices are preferably normalized so that the product outputs are 1 and the waste inputs −1. This makes it very convenient to combine the inventory matrices with the foreground systems as in FIG. 6.

In particular, the matrix A is a square matrix, which is indexed by process-product and process-waste pairs. The column-index of B and M are the same as the column-index of A. In addition, the row-index of M and the column-index of C are the same as the row-index of B.

Additional matrices with possible parameter values of uncertainty distributions or data quality indicators may also be stored in the same manner as the matrices A, B, and C in the data package.

When a foreground system 102 is linked to process datasets of a data package 114, the respective matrix columns thereof contain placeholders instead of the full processes.

For a background process j, the column j_{F} in the foreground matrix A_{F} contains only one non-zero entry on the diagonal, which is 1 for product outputs and −1 for waste inputs, similar to the ones of the linked data package. The column j_{F} of the intervention matrix BF of the foreground system only contains zero values. The process j is contained in the corresponding index Id_{A}_{_{F}}, of the foreground system and Idx_{A}_{_{B}}, of the background system. In this way the foreground system is linked with the background system as shown in FIG. 7.

Further, the scaling factor sⱼ for process j can be calculated by solving the equations of the foreground system:

$${A}_{F} {s}_{F} = f$$

The scaling factor can then be applied on the background system 104 for calculating direct and upstream result-contributions of process j in the combined system.

For example, scaling the column b_{B,j} of the intervention matrix B_{B} of the background system gives the direct inventory-contribution of process j. Summing up all scaled inventory-contributions of all background processes gives the inventory result of the background system gB which can be then added to the inventory result of the foreground system to get the total inventory result g of the model.

$${g}_{B} = {\sum }_{j} {s}_{j} {b}_{B , j}$$

The upstream result contributions for the upstream trees and Sankey diagrams can be calculated in a similar way.

Alternatively, the matrices of the background system 104 can be included as blocks into a combined calculation model. Further, efficient block-matrix algorithms can be applied for calculating results. For example, the inverse of the combined system can be calculated in the following way:

$${A}^{- 1} = ( \begin{matrix}{A}_{F}^{- 1} & 0 \\ Y & {A}_{B}^{- 1}\end{matrix} )$$

with

$$Y = - {A}_{B}^{- 1} {XA}_{F}^{- 1}$$

Typically, the blocks A_{F}, X and Y are very small compared to A_{B} and A_{B}⁻¹, which are retrieved from the data package, so that the calculation of A⁻¹ is fast (Srocka and Montiel 2021).

### REFERENCE NUMERALS

100 LCA system
102 foreground system
104 background system
106 background databases
108 foreground database
110 LCA software tool
114 data package
200 method
202 step of reading
204 step of creating an LCA model
206 the step of determining
208 the step on creating a combined LCA model
210 the step of implementing the (combined) LCA model
212 a common result interface
214 calculation model
216 results view

1. A system for implementing and/or providing a life cycle assessment,
the system comprising a foreground system communicating with a background system,
the background system comprising background databases including background process datasets,
the foreground system comprising a foreground database including foreground process datasets,
and a computing device for creating a life cycle assessment model and for performing a life cycle assessment (LCA),
the foreground system being configured to link to at least one data package including the background process datasets stored in a defined package format,
the computing device being configured to receive the background process datasets from the at least one data package.

2. The system of claim 1, wherein the at least one data package is configured to reduce the calculation time of the foreground system.

3. The system of claim 1, wherein the at least one data package comprises pre-calculated matrices associated with the background process datasets of the background system that are configured to be linked by the computing device to the foreground system, and wherein the matrices are stored in a binary format.

4. The system of claim 1, wherein the at least one data package further comprises meta-data of all elements that are stored in the background databases, and index files for linking the meta-data to the specific rows and columns of the pre-calculated matrices of the data packages.

5. The system of claim 1, wherein the at least one data package further comprises meta-data files comprising information about the library.

6. The system of claim 5, wherein the at least one data package comprises all meta-data of the elements stored in the library.

7. The system of claim 1, wherein the at least one data package is configured to store the pre-calculated matrices in the formats corresponding to the type of the background databases.

8. The system of claim 7, wherein the at least one data package is configured to store the background matrices either in a sparse format in cases where the background databases comprise a unit process database, or in a dense format in cases where the background databases includes input-output models.

9. The system of claim 1, wherein the at least of data package is configured to facilitate the creation of a combined life cycle assessment model incorporating the background process datasets and the foreground process datasets of the foreground system into the computing device.

10. The system of claim 1, wherein the system is configured to isolate the foreground system from the background system, preferably when graphical editors are used.

11. The system of claim 1, wherein the system is configured to track down every result-contribution that is obtained from the LCA to a corresponding background process dataset of a respective supply chain.

12. The system of claim 1, wherein the background system may comprises a plurality of data packages, each including pre-calculated matrices and linked to the foreground database of the foreground system.

13. The system of claim 12, wherein the at least one data package is configured to be linked to other data packages recursively.

14. A method for performing an LCA using the LCA system according to claim 1, the method comprising the steps of:
reading the foreground database of the foreground system;
creating, using the computing devices, an LCA model for the foreground system;
determining whether the LCA model is connected to at least one data package for fast data processing;
if at least one data package is connected, creating a combined LCA model by linking the at least one data package to the LCA model; and
implementing the combined LCA model.

15. The method of claim 14, wherein the method further comprises implementing the LCA model if no data packages are connected.
